(19) United States
(12) Patent Application Publication
(10) Pub. No.: US 2022/0319772 A1
(43) Pub. Date: Oct. 6, 2022

(54) METHOD FOR PREPARING A HIGH-PERFORMANCE ND-FE-B ISOTROPIC MAGNETIC POWDER

(71) Applicant: BAOTOU KERUI MICRO MAGNET NEW MATERIALS CO., LTD., Baotou (CN)

(72) Inventors: Jirong Lin, Baotou (CN); Ruigang Wang, Baotou (CN); Zhigang Wang, Baotou (CN); Jianxin Ren, Baotou (CN)

(73) Assignee: BAOTOU KERUI MICRO MAGNET NEW MATERIALS CO., LTD., Baotou (CN)

(21) Appl. No.: 17/522,701

(22) Filed: Nov. 9, 2021

(30) Foreign Application Priority Data
Apr. 1, 2021 (CN) 202110356690.4

(51) Int. Cl. H01F 41/02; B22F 9/08; B22F 9/04; B22F 1/00; H01F 1/057

(52) U.S. Cl. CPC H01F 41/0253; B22F 9/08; B22F 9/04; B22F 1/0085; H01F 1/0571; B22F 2009/048; B22F 2301/355; B22F 2201/11

(57) ABSTRACT

A high-performance Nd—Fe—B isotropic magnetic powder and a preparation method thereof are disclosed. The method includes S1, smelting and refining ingredients under vacuum to obtain an alloy ingot, crushing the alloy ingot to obtain an alloy block, wherein the smelting is conducted at a temperature of 1,350-1,450° C., and the refining is conducted at a temperature of 1,335-1,430° C. and a pressure of 900-1,100 Pa in an inert gas atmosphere for 3-7 minutes; S2, melting the alloy block obtained in step S1 to obtain an alloy solution, rapidly quenching the alloy solution to form a Nd—Fe—B rapidly-quenched alloy plate; S3, crushing the Nd—Fe—B rapidly-quenched alloy plate obtained in step S2 to obtain a magnetic powder; S4, subjecting the magnetic powder to a crystallization heat treatment in an inert gas atmosphere, and cooling to obtain the Nd—Fe—B isotropic magnetic powder.

### CROSS REFERENCE TO RELATED APPLICATION

This patent application claims the benefit and priority of Chinese Patent Application No. 202110356690.4 filed on Apr. 1, 2021, the disclosure of which is incorporated by reference herein in its entirety as part of the present application.

### TECHNICAL FIELD

The present disclosure relates to the technical field of rare earth permanent magnet materials, in particular to a method for preparing a high-performance Nd—Fe—B isotropic magnetic powder.

### BACKGROUND ART

Neodymium-iron-boron (Nd—Fe—B) rare earth magnetic materials could be essentially divided into two types according to the production process. One is sintered Nd—Fe—B, and the other is isotropic Nd—Fe—B. The basic raw material of isotropic Nd—Fe—B magnet is called Nd—Fe—B rapidly-quenched magnetic powder. The large-scale production and application of rapidly-quenched magnetic powder began in the late 1980s. The basic raw materials of the Nd—Fe—B rapidly-quenched magnetic powder are rare earth metals praseodymium and neodymium, boron, and metal iron. The production process of rapidly-quenched magnetic powder is very complex, mainly including smelting, rapidly quenching, crushing to magnetic powder and crystallizing the magnetic powder, etc.

The development and research in this field in China has a history of more than 20 years, but for the above reasons, there is no final breakthrough in key technologies, especially in how to control the rapid solidification rate of molten alloy, and the progress is slow. Therefore, a small-scale production has been achieved in a few domestic manufacturers; however, they do not have the capacity to produce high-performance magnetic on a large scale.

The applicant has been researching and developing various production processes of high-performance Nd—Fe—B rapidly-quenched magnetic powder. Through a large number of experimental studies, it has been found that even if a powerful vacuum unit is used to keep the rapid quenching furnace in a high vacuum state, the obtained magnetic powder still has very high oxygen content, and thereby the magnetic performance of the magnetic powder is not high. Further, it has been found that in the high vacuum state, materials such as vacuum furnace wall and crucible would continuously release a large amount of water vapor, oxygen, and nitrogen at high temperature, and these impurity gases would have a great opportunity to oxidize high-temperature Nd—Fe—B in the nozzle and crucible before being discharged, thereby improving the oxygen content of magnetic powder, destroying the lattice structure of Nd—Fe—B, and reducing the magnetic performance of magnetic powder. Therefore, how to reduce the oxygen content in magnetic powder is one of the important ways to produce high-performance magnetic powder.

For example, CN103862052A discloses a forming method of isotropic Nd—Fe—B magnet. The method includes the steps of smelting raw materials into a pre-alloyed ingot, amorphizing the pre-alloyed ingot to obtain a rapidly quenched alloy, ball milling the rapidly-quenched alloy to obtain a powder, mixing the powder with a binder to form a slurry, and forming the slurry into a magnet, and further includes the step of treating the powder surface with a surface treatment agent, which could reduce the oxygen content of isotropic Nd—Fe—B.

CN111755237A discloses a Nd—Fe—B magnet and a method for regulating the grain size and particle size distribution of the coarse-grained layer of the Nd—Fe—B magnet. In the method, the Nd—Fe—B rapidly-quenched magnetic powder was pickled with an acidic solution, washed and dried to reduce the oxygen content on the surface of the Nd—Fe—B rapidly-quenched magnetic powder by at least 200 ppm. The rapidly-quenched magnetic powder prepared by this method makes it possible to improve the coercivity of isotropic Nd—Fe—B magnet and anisotropic Nd—Fe—B magnet.

Although the above existing technologies could reduce the oxygen content to a certain extent by a surface treatment of rapidly-quenched magnetic powder, the effect is not good. In addition, the existing production process needs to be improved and the operation cost is high, so it is impossible to popularize on a large scale.

### SUMMARY

In order to solve the above technical problems, the present disclosure provides a method for preparing a high-performance neodymium-iron-boron isotropic magnetic powder. The method allows effectively reducing the oxygen content by controlling parameters such as the pressure value and flow rate of the inert gas in the rapid quenching furnace. Thus, the prepared rapidly-quenched magnetic powder exhibits improved performance by not less than 10% than the same kind of magnetic powder.

In order to achieve the above object, the present disclosure provides the following technical solutions:

The present disclosure provides a method for preparing a high-performance neodymium-iron-boron isotropic magnetic powder, comprising the following steps:
S1, smelting alloy
smelting and refining ingredients under vacuum to obtain an alloy ingot, and crushing the alloy ingot to obtain an alloy block,
wherein the smelting is conducted at a temperature of 1,350-1,450° C., and the refining is conducted at a temperature of 1,335-1,430° C. and a pressure of 900-1,100 Pa in an inert gas atmosphere for 3-7 minutes;
S2, rapidly quenching alloy solution
melting the alloy block obtained in step S1 to obtain an alloy solution, rapidly quenching the alloy solution to form a Nd—Fe—B rapidly-quenched alloy plate;
S3, crushing alloy plate
crushing the Nd—Fe—B rapidly-quenched alloy plate obtained in step S2 to obtain a magnetic powder; and
S4, crystallization heat treatment
subjecting the magnetic powder obtained in step S3 to a crystallization heat treatment in an inert gas atmosphere, and cooling to obtain the Nd—Fe—B isotropic magnetic powder.

In some embodiments, the smelting in step S1 is conducted at a temperature of 1,395° C. In some embodiments, the refining is conducted at 1,380° C. and 1,000 Pa in an argon gas atmosphere for 5 minutes.

In some embodiments, the alloy block in step S1 has a particle size of 10-50 mm, and preferably 15-45 mm. The particle size of the alloy block is determined with screens having different pore diameters. For example, the alloy block could pass through the screen having a pore diameter of 50 mm, but could not pass through the screen having a pore diameter of 10 mm.

In some embodiments, rapidly quenching the alloy solution in step S2 is conducted under conditions: controlling a charging flow rate of the inert gas of 0.2-1.5 m³/min, and maintaining a pressure of 200-2,000 Pa.

In some embodiments, rapidly quenching the alloy solution in step S2 is conducted under conditions: controlling a charging flow rate of the inert gas of 0.4-1.0 m³/min, and maintaining a pressure of 400-1,900 Pa.

In some embodiments, the magnetic powder in step S3 has a particle size of 45-380 μm, and preferably 58-250 μm. The particle size of the magnetic powder is determined with screens having different pore diameters. For example, the magnetic powder could pass through the screen having a pore diameter of 380 μm, but could not pass through the screen having a pore diameter of 45 μm.

In some embodiments, the crystallization heat treatment in step S4 is conducted at a temperature of 630-700° C. for 9-18 min, and preferably at a temperature of 650-680° C. for 10-15 min.

In some embodiments, the inert gas in steps S 1 and S4 is argon gas.

The present disclosure also provides a high-performance neodymium-iron-boron isotropic magnetic powder prepared by the above-mentioned method.

The present disclosure also provides a neodymium-iron-boron magnet, which is prepared from the neodymium-iron-boron isotropic magnetic powder as prepared by the above-mentioned method.

The technical solutions according to the present disclosure has the following beneficial effects:

(1) The present disclosure allows effectively reducing the oxygen content of the magnetic powder and improving the magnetic performance of the rapidly-quenched magnetic powder by improving the parameters such as alloy smelting, refining, and pressure and flow rate of the inert gas in the rapid quenching furnace.

(2) In the present disclosure, there is no need to modify the existing process equipment, and meanwhile there is no need to use additional organic reagents. Therefore, the method is low in operation cost, greener and more environmentally friendly, and thus is suitable for large-scale promotion and application.

### DETAILED DESCRIPTION OF THE EMBODIMENTS

The description of the following embodiments is only used to help understand the method and the core idea of the present disclosure. It should be pointed out that for those of ordinary skill in the art, without departing from the principle of the present disclosure, several improvements and modifications could be made to the present disclosure, and these improvements and modifications also fall within the protection scope of the claims of the present disclosure. The following description of the disclosed embodiments enables those skilled in the art to implement or use the present disclosure. Various modifications to these embodiments will be obvious for those skilled in the art, and the general principles defined herein could be implemented in other embodiments without departing from the spirit or scope of the present disclosure. Therefore, the present disclosure will not be limited to the embodiments described herein, but could be applied to a wider scope consistent with the principles and novel features disclosed herein. Although any methods and materials similar or equivalent to those described in the present disclosure could be used in implementing or testing of the present disclosure, the preferred methods and materials are listed herein.

Unless otherwise defined, all technical and scientific terms used herein have the same meaning as commonly understood by those of ordinary skill in the technical field to which the present disclosure belongs.

The ingredients used in examples of the present disclosure consisted of the following ingredients, in percentages by weight, 26.2% of rare earth metals praseodymium and neodymium, 4.7% of boron iron, 0.2% of metal niobium, 2.0% of metal cobalt, and the balance of ingot iron. Specifically, the rare earth metals praseodymium and neodymium had a purity of 99.9%, in which the oxygen content was less than 400 ppm and the nitrogen content was less than 60 ppm. The ingot iron had a carbon content of less than 400 ppm, and a silicon content of less than 1,500 ppm. The boron iron had a boron content of 20.2%. The metal niobium had a purity of 99.5%. The metal cobalt had a purity of 99.9%, in which the oxygen content was less than 500 ppm, and the nitrogen content was less than 70 ppm.

### BASIC EXAMPLE

### A High-Performance Neodymium-Iron-Boron Isotropic Magnetic Powder and its Preparation Method

The high-performance neodymium-iron-boron isotropic magnetic powder was prepared according to the following steps:
S1. smelting alloy
Ingredients were added into an intermediate frequency vacuum induction furnace, smelted and refined therein, and cast into an alloy ingot. The alloy ingot was crushed, obtaining an alloy block with a particle size of 10-50 mm.
The smelting was conducted at a temperature of 1,350-1,450° C. The refining was conducted at a temperature of 1,335-1,430° C. and a pressure of 900-1,100 Pa in an inert gas atmosphere for 3-7 minutes.
S2. rapidly quenching alloy solution
The alloy block obtained in step S1 was added to a vacuum induction melting-rapid quenching furnace, and molten therein, obtaining an alloy solution. The alloy solution was rapidly quenched into a Nd—Fe—B rapidly-quenched alloy plate.
Rapidly quenching the alloy solution was conducted under conditions: charging argon gas through a vacuum ball valve, maintaining a charging rate of argon gas of 0.2-1.5 m³/min; adjusting a vacuum butterfly valve, and maintaining a pressure of 200-2,000 Pa.
S3. crushing alloy plate
The Nd—Fe—B rapidly-quenched alloy plate obtained in step S2 was crushed, obtaining a magnetic powder with a particle size of 45-380 μm.
S4. crystallization heat treatment
The magnetic powder obtained in step S3 was subjected to a crystallization heat treatment in an argon gas atmosphere, and cooled, obtaining the neodymium-iron-boron isotropic magnetic powder.
The crystallization heat treatment was conducted at a temperature of 630-700° C. for 9-18 min.

### Examples 1-5

### A High-Performance Neodymium-Iron-Boron Isotropic Magnetic Powder and its Preparation Method

The process parameters in the methods for preparing the high-performance Nd—Fe—B isotropic magnetic powders are shown in Table 1.

TABLE 1

| Parameters | Example 1 | Example 2 | Example 3 | Example 4 | Example 5 |
|---|---|---|---|---|---|
| Temperature for | 1350 | 1450 | 1395 | 1395 | 1395 |
| smelting/° C. | | | | | |
| Temperature for | 1335 | 1430 | 1380 | 1380 | 1380 |
| refining/° C. | | | | | |
| Pressure for | 1100 | 900 | 1000 | 1000 | 1000 |
| refining/Pa | | | | | |
| Time for refining/min | 7 | 3 | 5 | 5 | 5 |
| Particle size of the | 10 | 50 | 15 | 45 | 30 |
| alloy block/mm | | | | | |
| Charging flow rate | 0.2 | 1.5 | 0.4 | 1.0 | 0.6 |
| of argon gas/(m³/min) | | | | | |
| Pressure/Pa | 200 | 2000 | 800 | 1900 | 1330 |
| Particle size of the | 380 | 45 | 58 | 250 | 200 |
| magnetic powder/μm | | | | | |
| Temperature for | 630 | 700 | 650 | 680 | 665 |
| crystallization heat | | | | | |
| treatment/° C. | | | | | |
| Time/min | 18 | 9 | 15 | 10 | 13 |

### Comparative Example 1

### A Neodymium-Iron-Boron Isotropic Magnetic Powder and its Preparation Method

This comparative example was performed according to the method as described in Example 5, expect that rapidly quenching alloy solution in step S2 was conducted under conditions: a vacuum degree in the vacuum induction melting-rapid quenching furnace was 2×10⁻² Pa, and argon gas was not charged.

### Comparative Example 2

### A Neodymium-Iron-Boron Isotropic Magnetic Powder and its Preparation Method

This comparative example was performed according to the method as described in Example 5, expect that rapidly quenching alloy solution in step S2 was conducted under conditions: argon gas was charged through a vacuum ball valve to a pressure of 1,330 Pa, and the exhaust vacuum butterfly valve was closed.

### Comparative Example 3

### A Neodymium-Iron-Boron Isotropic Magnetic Powder and its Preparation Method.

This comparative example was performed according to the method as described in Example 5, expect that argon gas was charged through a vacuum ball valve to a pressure of 3,000 Pa, and the exhaust vacuum butterfly valve was closed.

### Comparative Example 4

### A Neodymium-Iron-Boron Isotropic Magnetic Powder and its Preparation Method

The high-performance neodymium-iron-boron isotropic magnetic powder was prepared according to the following steps:
S1. smelting alloy
Ingredients were added into an intermediate frequency vacuum induction furnace, smelted and refined therein, and cast into an alloy ingot. The alloy ingot was crushed, obtaining an alloy block with a particle size of 40 mm.
The smelting was conducted at a temperature of 1,500° C. The refining was conducted at a temperature of 1,450° C. and a pressure of 200 Pa in an inert gas atmosphere for 25 minutes.
S2. rapidly quenching alloy solution
The alloy block obtained in step S1 was added to a vacuum induction melting-rapid quenching furnace, and molten therein, obtaining an alloy solution. The alloy solution was rapidly quenched into a Nd—Fe—B rapidly-quenched alloy plate.
Rapidly quenching the alloy solution was conducted under conditions: charging argon gas through a vacuum ball valve, maintaining a charging flow rate of argon gas of 3 m³/min; adjusting a vacuum butterfly valve, and maintaining a pressure of 2,500 Pa.
S3. crushing alloy plate
The Nd—Fe—B rapidly-quenched alloy plate obtained in step S2 was crushed, obtaining a magnetic powder with a particle size of 200 μm.
S4. crystallization heat treatment
The magnetic powder obtained in step S3 was subjected to a crystallization heat treatment in an argon gas atmosphere, and cooled, obtaining the neodymium-iron-boron isotropic magnetic powder.
The crystallization heat treatment was conducted at 720° C. for 10 min.

### Comparative Example 5

### A Neodymium-Iron-Boron Isotropic Magnetic Powder and its Preparation Method

The high-performance neodymium-iron-boron isotropic magnetic powder was prepared according to the following steps:
S1. smelting alloy
Ingredients were added into an intermediate frequency vacuum induction furnace, smelted and refined therein, and cast into an alloy ingot. The alloy ingot was crushed, obtaining an alloy block with a particle size of 40 mm.
The smelting was conducted at 1,300° C. The refining was conducted at a temperature of 1,285° C. and a pressure of 1,500 Pa in an inert gas atmosphere for 10 minutes.
S2. rapidly quenching alloy solution
The alloy block obtained in step S1 was added to a vacuum induction melting-rapid quenching furnace, and molten therein, obtaining an alloy solution. The alloy solution was rapidly quenched into a Nd—Fe—B rapidly-quenched alloy plate.
Rapidly quenching the alloy solution was conducted under conditions: charging argon gas through a vacuum ball valve, maintaining a charging flow rate of argon gas of 0.1 m³/min; adjusting a vacuum butterfly valve, and maintaining a pressure of 80 Pa.
S3. crushing alloy plate
The Nd—Fe—B rapidly-quenched alloy plate obtained in step S2 was crushed, obtaining a magnetic powder with a particle size of 200 μm.
S4. crystallization heat treatment
The magnetic powder obtained in step S3 was subjected to a crystallization heat treatment in an argon atmosphere, and cooled, obtaining the neodymium-iron-boron isotropic magnetic powder.
The crystallization heat treatment was conducted at 600° C. for 20 min.

The neodymium-iron-boron isotropic magnetic powders prepared in Examples 1-5 and Comparative Examples 1-5 were subjected to an oxygen content analysis and a magnetic performance analysis (VSM measurement). The results are shown in Table 2.

TABLE 2
Magnetic performance of neodymium-
iron-boron isotropic magnetic powders

| | Oxygen | Br | Hci | BHₘₐₓ |
|---|---|---|---|---|
| | content % | (kGs) | (kOe) | (MGoe) |
| Example 1 | 0.09 | 8.69 | 9.32 | 14.4 |
| Example 2 | 0.02 | 8.70 | 9.63 | 14.6 |
| Example 3 | 0.07 | 8.71 | 9.50 | 14.8 |
| Example 4 | 0.02 | 8.72 | 9.56 | 14.9 |
| Example 5 | 0.02 | 8.79 | 9.62 | 15.7 |
| Comparative | 0.21 | 8.57 | 9.06 | 13.6 |
| Example 1 | | | | |
| Comparative | 0.15 | 8.62 | 9.24 | 13.9 |
| Example 2 | | | | |
| Comparative | 0.13 | 8.61 | 9.26 | 14.1 |
| Example 3 | | | | |
| Comparative | 0.11 | 8.63 | 9.25 | 14.2 |
| Example 4 | | | | |
| Comparative | 0.14 | 8.59 | 9.21 | 13.8 |
| Example 5 | | | | |

The applicant found that under high vacuum conditions, when oxygen molecules appeared in the rapid quenching furnace due to various reasons, its mean free path would be very long. For example, at a vacuum degree of 1.33×10⁻² Pa, the mean free path of oxygen molecules under ideal conditions is 0.52 m. That is to say, oxygen molecule, with an average velocity of 450 m/s, once appears in the vacuum furnace, it has enough chances to reach the neodymium-iron-boron stream or the surface of the liquid in the crucible below the nozzle, and react with neodymium atoms in the neodymium-iron-boron, before being pumped away by the vacuum unit. This is the reason why the oxygen content in the magnetic powder could not be reduced by using high vacuum means.

Meanwhile, the applicant found that if a small amount of argon gas was charged and retained in the rapid quenching furnace, when the pressure reached 133 Pa, the mean free path of oxygen molecules would rapidly drop to 0.052 mm, and when the pressure of argon gas in the rapid quenching furnace reached 2,000 Pa, the mean free path of oxygen atoms at the same temperature would drop to 2.0 μm or less. An inert gas such as argon gas forms a complete protective layer around the neodymium-iron-boron liquid. At this time, the frequency of collisions between gas molecules reached 70 million times per second! Therefore, if oxygen atoms appear in the rapid quenching furnace, most of the oxygen atoms would be discharged from the rapid quenching furnace by the vacuum pump before they have a chance to reach the surface of the Nd—Fe—B liquid. By continuously charging argon gas while discharging the contaminated argon gas by a vacuum pump, harmful molecules such as water vapor, oxygen, and nitrogen are carried away, which could effectively reduce the amount of harmful molecules such as water vapor, oxygen, and nitrogen in the rapid quenching furnace.

After a series of tests and studies, it is shown that if argon gas is continuously charged into the rapid quenching furnace meanwhile the gas in the furnace is continuously pumped off with a vacuum pump, and a continuous flow and exchange are maintained such that the pressure is maintained at 200 Pa or more, then the rapidly-quenched magnetic powder has a greatly reduced oxygen content. When the pressure of argon gas is 1,330 Pa, the magnetic powder has the lowest oxygen content. Also, experiments have proven that a better effect could be achieved when charging argon gas at the bottom of the furnace body and pumping off the gas and carrying away harmful gases at the top of the furnace body. However, the pressure in the furnace could not be too high, otherwise the oxygen content would no longer decrease due to the gas swirl caused by the high-speed rotation of the rapid quenching roll, and the gas swirl would also make the rapid quenching process more complicated and affect the magnetic performance.

In summary, the present disclosure allows effectively reducing the oxygen content of the magnetic powder and improving the magnetic performance of the rapidly-quenched magnetic powder by improving parameters such as the smelting, refining, and the pressure and flow rate of the inert gas in the rapid quenching furnace.

Also, in the present disclosure, there is no need to modify the existing process equipment, and there is no need to use additional organic reagents. The method is low in operation cost, greener and more environmentally friendly, and thus is suitable for large-scale promotion and application.

The above is a further description of the present disclosure in conjunction with specific embodiments, but these embodiments are only exemplary and do not make any limitation on the scope of the present disclosure. Those skilled in the art should understand that the details and forms of the technical solution of the present disclosure could be modified or replaced without departing from the spirit and scope of the present disclosure, but these modifications and replacements shall fall within the protection scope of the present disclosure.

1. A method for preparing a Nd—Fe—B isotropic magnetic powder, comprising
S1. smelting alloy
smelting and refining ingredients under vacuum to obtain an alloy ingot, and crushing the alloy ingot to obtain an alloy block,
wherein the smelting is conducted at a temperature of 1,350-1,450° C., and the refining is conducted at a temperature of 1,335-1,430° C. and a pressure of 900-1,100 Pa in an inert gas atmosphere for 3-7 minutes;
S2. rapidly quenching alloy solution
melting the alloy block obtained in step S1 to obtain an alloy solution, rapidly quenching the alloy solution to form a Nd—Fe—B rapidly-quenched alloy plate;
S3. crushing alloy plate
crushing the Nd—Fe—B rapidly-quenched alloy plate obtained in step S2 to obtain a magnetic powder; and
S4. crystallization heat treatment
subjecting the magnetic powder obtained in step S3 to a crystallization heat treatment in an inert gas atmosphere, and cooling, to obtain the Nd—Fe—B isotropic magnetic powder.

2. The method as claimed in claim 1, wherein the ingredients in step S1 comprise rare earth metals praseodymium and neodymium, ingot iron, ferroboron, metal niobium, and metal cobalt.

3. The method as claimed in claim 1, wherein the alloy block in step S1 has a particle size of 10-50 mm.

4. The method as claimed in claim 1, wherein rapidly quenching the alloy solution in step S2 is conducted under conditions: controlling a charging flow rate of the inert gas of 0.2-1.5 m³/min, and maintaining a pressure of 200-2,000 Pa.

5. The method as claimed in claim 1, wherein rapidly quenching the alloy solution in step S2 is conducted under conditions: controlling a charging flow rate of the inert gas of 0.4-1.0 m³/min, and maintaining a pressure of 400-1,900 Pa.

6. The method as claimed in claim 1, wherein the magnetic powder in step S3 has a particle size of 45-380 μm.

7. The method as claimed in claim 1, wherein the crystallization heat treatment in step S4 is conducted at a temperature of 630-700° C. for 9-18 min.

8. The method as claimed in claim 1, wherein the inert gas in steps S1 and S4 is argon gas.

9. A Nd—Fe—B isotropic magnetic powder prepared by the method as claimed in claim 1.

10. A Nd—Fe—B magnet, which is prepared from the Nd—Fe—B isotropic magnetic powder as prepared by the method as claimed in claim 1.
